(19) United States
(12) Patent Application Publication
(10) Pub. No.: US 2007/0203901 A1
(43) Pub. Date: Aug. 30, 2007

(54) Data transcription and management system and method

(75) Inventors: Manuel Prado, Santa Cruz, CA (US); Benjamin S. Sanders, Brooklyn, NY (US)

Correspondence Address: PROCOPIO, CORY, HARGREAVES & SAVITCH LLP, 530 B STREET, SUITE 2100, SAN DIEGO, CA, 92101, US

(73) Assignee: Manuel Prado

(21) Appl. No.: 11/361,176

(22) Filed: Feb. 24, 2006

(51) Int. Cl. G06F 17/30

(52) U.S. Cl. 707/5

(57) ABSTRACT

A data storage and management system includes a data base in which documents are stored. The data base also includes a series of selected keywords each associated with one or more document inserts, the document inserts comprising advertisements, information, on-screen control buttons for performing a series of functions, and links for access to websites and other sources of information. Each document in the data base is scanned and a list of keywords is retrieved from the document. The retrieved keywords are compared with the selected keywords and at least one document insert is selected for each retrieved keyword in the list which matches a selected keyword. The document inserts are inserted at appropriate positions in the document each time it is retrieved and viewed by an authorized user. The system may be associated with an online medical record transcription service with inserts added to documents which are transcribed or otherwise submitted for storage in the data base.

### BACKGROUND OF THE INVENTION

The present invention relates generally to data management systems and methods, and is particularly concerned with web-based data management systems which include transcription services for health care providers and the like.

Medical transcription and transcription of other types of data has become a thriving industry. In this industry, health care providers such as doctors dictate medical records and receive a transcript of the dictation to be placed in a patient's file. Other industries require similar transcription services, such as the legal profession. On-line data transcription systems are currently available for medical professionals and the like, in which the professional such as a doctor or other medical personnel can record dictation via the telephone using a unique user id, or onto a digital recorder. If using a digital recorder, the files are then uploaded from the recorder onto the doctor's computer. Dictation files are then uploaded to a specific type of website known as an ftp website (file transfer protocol). If the doctor uses a telephone dictation system, this will happen automatically when the phone is hung up. If a digital recorder is used, files are uploaded by the doctor from his computer to a specific ftp site.

Transcriptionists then download the recorded files to their own computers, listen to the recording and type up the transcript. The transcriptionist recognizes a doctor's telephone files from the unique user id he keyed in prior to making the recording. If a digital recorder was used, then the doctor has a unique ftp site which only he and the transcriptionist can access. The transcribed document is sent to a central website and is uploaded to the specific user account, where it can be accessed by authorized users as needed. Such a transcription system is described, for example, in U.S. Patent Application Publication No. US 2003/0105631 of Habte, which includes routing information to automatically transmit the transcribed data to a secondary recipient.

Patent Application Publication No. US 2002/0019749 of Becker et al. describes a medical service facilitating system in which data recorded by a doctor is transcribed, and also includes the steps of checking for authorization of a recommended treatment by a payor, transmitting prescriptions to a pharmacy, and automatically scheduling follow-ups and referrals. Patent Application Publication No. US 2004/0015810 of Swinney describes a network-based transcribing service in which patient diagnosis and treatment data sent to the service is also sent to a research engine. Information is extracted from the data and a search is conducted based on various keywords. The physician can be informed about the latest treatment options, medical guidelines, and the like for his diagnosis by means of a pop-up window listing the headings of relevant articles and the like.

Although these and other known systems can augment a conventional, basic transcription system and provide a user with valuable information and assistance, there are many other services which may be useful in assisting a medical practitioner and the like in carrying out their work

### SUMMARY OF THE INVENTION

It is an object of the present invention to provide a new and improved data management system and method incorporating a document transcription service.

According to one aspect of the present invention, a data management method is provided, which comprises the steps of:

receiving and storing a series of documents in a data base;

selecting a series of keywords and associating each keyword with one or more document inserts, the document inserts comprising advertisements, information, buttons for performing a series of functions, and links;

scanning each document at least once and retrieving a list of keywords from the document;

comparing the retrieved keyword list with the selected keywords and selecting at least one document insert for each retrieved keyword in the list which matches a selected keyword; and

inserting the document inserts into the document each time it is viewed by an authorized user accessing the data base and viewing the document.

The method may include the steps of assigning a value to each keyword found in a document and sorting the keywords found by assigned value, inserting information related to each found keyword in the document file in order with the information related to the most valuable keyword found listed first, and delivering the document file to the user for viewing on a browser, downloading, or the like.

In an exemplary embodiment of the invention, the data base is provided as part of a web-based service provider system, and authorized users can access the system over the Internet. The method may also comprise permitting authorized users to edit documents online on their web browser, and inserting appropriate document inserts when a document is downloaded for viewing or editing. The method may also comprise the steps of permitting authorized users to select files for mailing, emailing, or faxing to selected recipients, rewriting selected files to place inserts in the file based on keywords found in the file, and delivering the fax, email, or mail with inserts to the selected recipients.

In this method and system, documents are stored in the database in their original, unaltered form, and document inserts are only made when an authorized user accesses the document. Whenever a user retrieves the file, selected images and data based on the keywords found in the file are inserted as inserts or pop-ups. The file only has to be scanned once for keywords. After images have been associated with the file, the file will be tagged so that the same images can be re-inserted each time the file is retrieved by the user, for whatever purpose.

In an exemplary embodiment of the invention, the information to be inserted in the document includes relevant advertisements as well as other information, articles or the like of potential interest to the author of the document. The value of each keyword may be assigned by a system administrator. Alternatively, or additionally, keyword value or priority may be based on the keyword associated with the highest bidder for advertisement placement. In the latter case, the method includes an auction manager which permits various entities to request insertion of advertisements based on various keywords. If more than one entity wishes to place an advertisement based on the appearance of a particular keyword, a bidding process is provided and the highest bidder will be given priority for advertisement placement, and will be billed for each placement of an advertisement based on that keyword.

In the case of a medical transcription and records system and method, the information placed in documents based on keywords found in the document may include advertisements for medication or medical devices for use in treatment, information on the latest treatments for a condition mentioned in the document, suggestions of appropriate drugs, treatments, lab or x-ray work based on keywords appearing in the document, and information on drugs which the doctor may be prescribing, such as effectiveness, side effects, how the drug should be taken, how it should be stored, and the like, and what the billing code is for the treatment in question. The advertisements and other information will be placed not only on documents which are transcribed, but also on documents scanned into the system, and on documents emailed, faxed or prepared for mailing by the system at the request of the user. Advertisements or other information may also be placed on the HTML web page itself, separate from the document. This option may be used, for example, when the user retrieves a document for editing purposes.

According to another aspect of the present invention, a data storage and management system is provided which comprises a central processing unit having at least one data base for storing a series of sets of documents each associated with an authorized user of the system and a first list of selected keywords, each keyword associated with at least one predetermined insert for insertion in a document containing that keyword, the central processing unit having a memory containing program instructions for scanning each document at least once, obtaining a second list of keywords from the document, comparing the second list to the first list and identifying the document insert or inserts associated with each keyword from the first list found in the second list, and inserting the identified document inserts into the document when a user retrieves the document from the data base.

The system may be Internet based and may include a website permitting authorized users to link to the database for access to their stored documents, which can be viewed on the HTML web page at their user terminal. The system may include an advertising manager program for allowing authorized clients to bid on advertisements to be placed in documents based on keywords found in the documents. The system will order advertisements to be inserted in documents based on the bid value, with the advertisement corresponding to the highest bid being inserted first.

The data management system and method of this invention will allow businesses and services such as health care providers, generally merchandise sales, law firms, publishing firms, and the like, to store all of their paper documents in digital form on a central database with all documents readily accessible by authorized users over the Internet or other network. At the same time, the documents will be displayed to the user when retrieved with added value information added inline with selected keywords, so that the user can see convenient, up to date information on various topics raised in the document, as well as advertisements for ordering goods or services related to certain keywords, links to relevant websites, and convenient buttons for use in ordering supplies, services, or the like which may be needed in association with keywords in the document.

### BRIEF DESCRIPTION OF THE DRAWINGS

The present invention will be better understood from the following description of an exemplary embodiment of the invention, taken in conjunction with the accompanying drawings, in which like reference numerals refer to like parts, and in which:

FIG. 1 is a block diagram of the hardware components of a data management system according to an exemplary embodiment of the present invention;

FIG. 2 is a schematic flow diagram illustrating a data management process according to the exemplary embodiment of the invention;

FIG. 3 is a more detailed flow diagram of the steps for downloading and handling documents in the system;

FIG. 4 is a flow diagram illustrating the steps carried out by the insertion manager of FIG. 3;

FIG. 5 is a flow diagram illustrating the steps carried out by the transcription manager of FIG. 3;

FIG. 6 is a flow diagram illustrating the steps carried out by the advertising manager of FIG. 4;

FIG. 7 is an example of a document screen with information inserted according to the exemplary embodiment of the invention;

FIG. 8 illustrates a screen display providing during an auction carried out by the advertising manager of FIG. 6;

FIG. 9 is a screen display similar to FIG. 8 illustrating a subsequent step in the auction process; and

FIG. 10 is a screen display similar to FIG. 9 but illustrating a different outcome to the process.

### DETAILED DESCRIPTION OF THE DRAWINGS

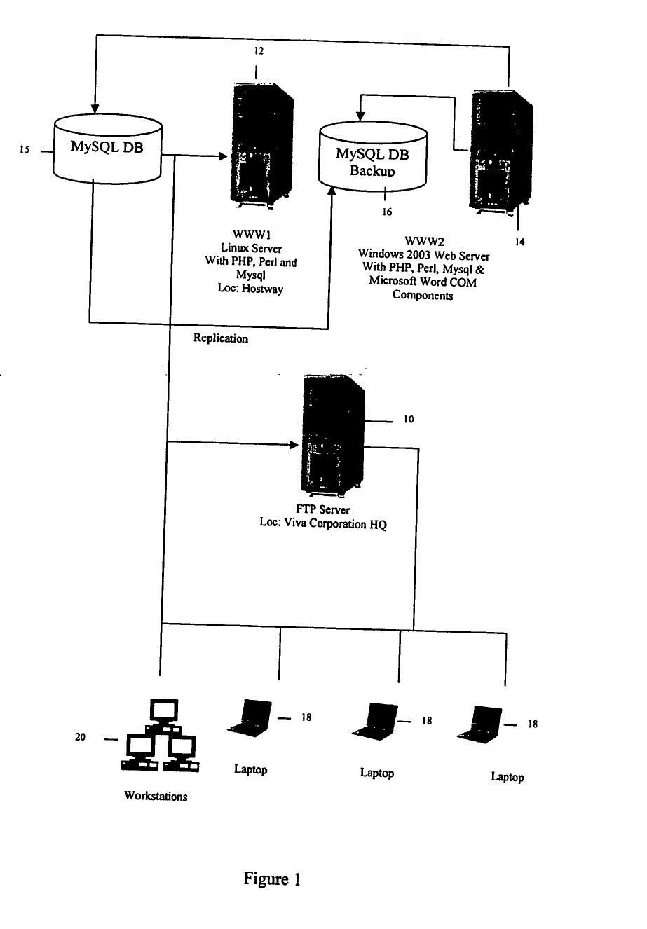

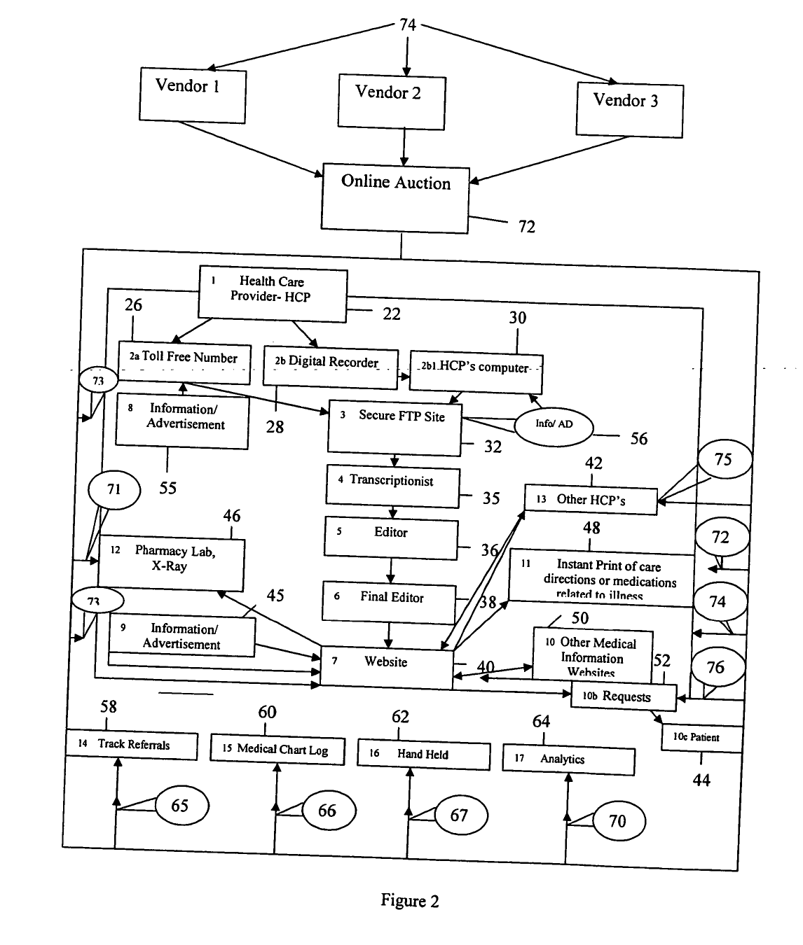

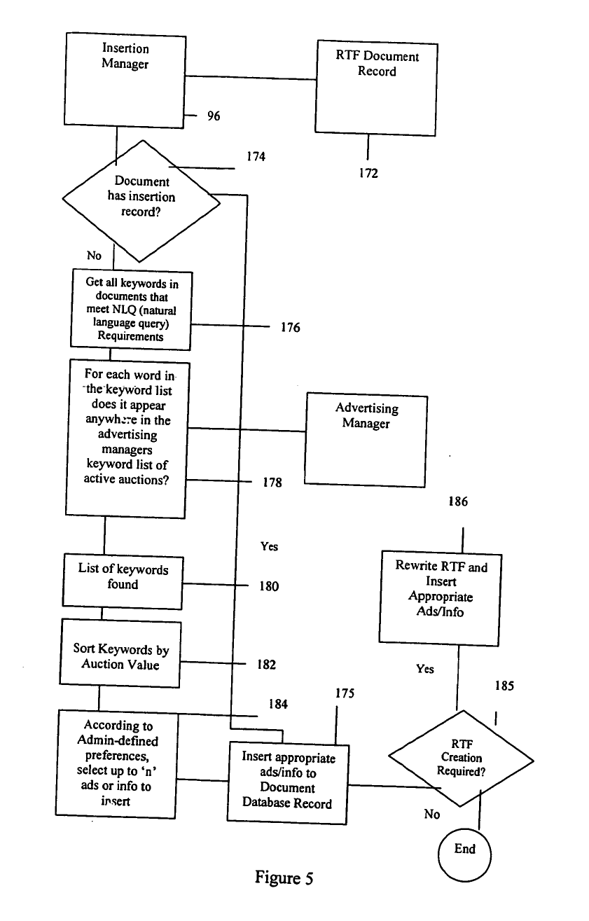

FIG. 1 illustrates the hardware components of a web or internet based data management system according to an exemplary embodiment of the invention, while FIGS. 2 to 10 illustrate the method steps carried out by the system. Although the system in the exemplary embodiment involves data management and transcription services particularly designed for the medical field, it will be understood that the system could readily be used for data management and transcription in other fields, such as sales, law, publishing, and the like. The data management system and method allows authorized users to download and store various documents on their own private sites within a central website, as well as to perform various other tasks such as document editing and printing, sending communications by email, fax, or regular mail to selected addressees, ordering various items, and the like. Each private site may also have sub-sites which are accessible to clients to view various records.

The basic components of the system comprise a website or central processing system having an ftp (file transfer protocol) server 10 and two associated web servers 12, 14 each having an associated memory storage or data base 15, 16, respectively. The website servers can be accessed via laptops 18 or desktop computers 20 over the internet, or by local computers in a local network. Individuals accessing the system may be system administrators, customers such as doctors or other medical personnel where the system is a medical data management system, patients, and vendors or potential advertisers.

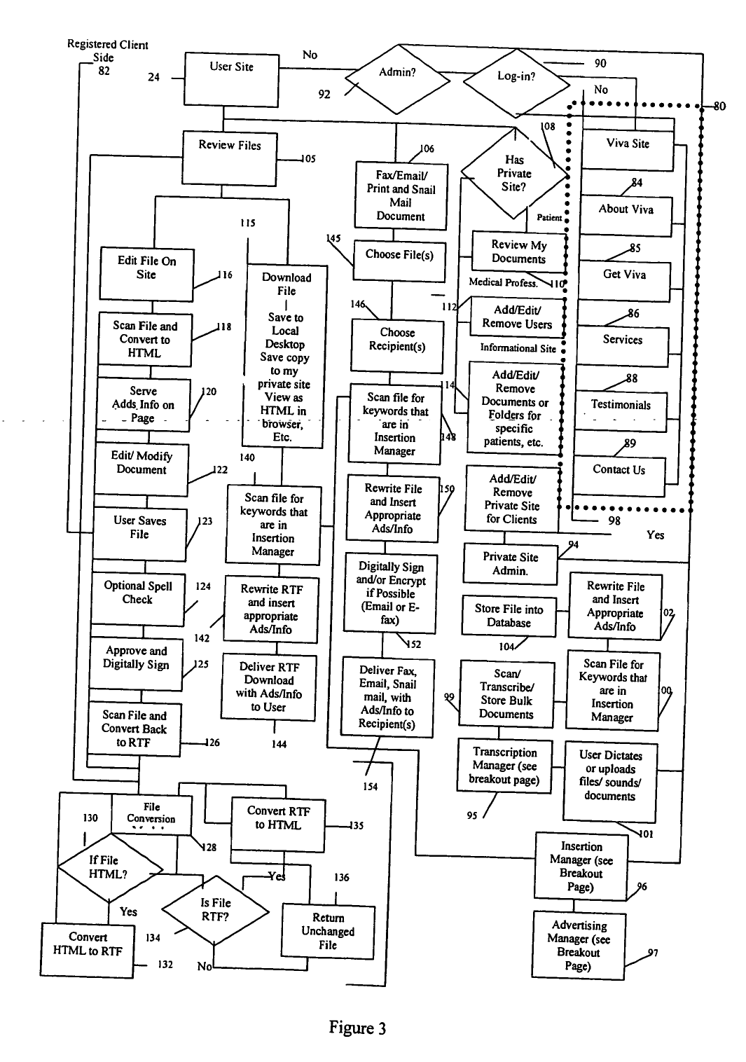

FIG. 2 is a basic overview of some of the method steps carried out in the system of FIG. 1, while FIG. 3 is a more detailed flow diagram illustrating the sequence of operations when an authorized user accesses the system. An authorized user such as a health care provider 22 can access their private user site 24 at the website in various ways. One way is directly from their own computer 25, as will be described in more detail in connection with FIG. 3. FIG. 2 illustrates possible options for a doctor to download a medical record to be transcribed. One option is to call a toll free number (step 26), enter their user password, and dictate the record directly. The other option is to dictate a series of medical records into a digital recorder (step 28) and then to download the records onto their computer (step 30). In the first case, the dictated record is uploaded automatically to the ftp server 10 of FIG. 1, in step 32. In the second case, the doctor logs onto the website and uploads the files from his computer to the ftp server 10. The audio files are then forwarded to a transcriptionist for transcribing or for transcription by a computer using voice recognition technology (step 35), the transcribed files are edited (steps 36 and 38), and then downloaded back to the website (step 40). This is a basic web based transcription system.

The data handling system and method of the exemplary embodiment of this invention augments a basic transcription system and makes it more flexible and useful to the medical provider. In the present invention, other health care providers can access the website (step 42) and may be provided with access to a particular patient record on a private site if authorized by the doctor or medical group owning or using that site. The original doctor can also authorize release of information by email, voicemail, or fax to other health care providers in step 42. The system also allows an authorized user with a private site to set up private sub-sites within their site, for access by patients or other authorized individuals, and allows a doctor to send relevant information to a patient by email, voice mail or fax (step 44).

One of the most important functions of the data management system and method is that of providing targeted information and advertisements to doctors and associated individuals, in the form of pop-ups or other types of insert based on keywords found in transcribed documents or other documents input by users into the system. The information may include relevant data directed to a particular keyword found in the document, in the form of information or advertisements (45), buttons which the doctor can click on to order appropriate tests, x-rays, or prescriptions (46), buttons to print out care directions or information on medications (48) which the doctor can hand out to a patient or health care personnel, links to other medical information websites (50), links for requesting an information kit or information about a drug, samples, or the like (52), to be sent to the doctor or directly to the patient, and the like. Although this information may be provided on the document itself when it is accessed by the doctor or other authorized personnel, it may also be provided at other times, for example pertinent information may be provided after the user has left a recording via the toll free number (see step 55), or when the user accesses the file transfer protocol website when uploading audio files (step 56).

The system also allows the user to track incoming or outgoing referrals to or from other doctors (step 58), and provides a medical chart log (step 60) to track who at a clinic or facility has accessed certain files. The latter function can be useful since it will enable a primary care provider to determine whether another health care provider for a patient has seen the medical transcript associated with one provider's visit with the patient, for example. The doctor can also access their secure site at the website via a hand held device such as a personal digital assistant (PDA), as seen in step 62. Another function provided by the system is the capability to run analytics or reports (step 64) such as how many patients were diagnosed with the same condition over a certain time period, or other types of reports. Each of these functions can be associated with pop-up advertisements or targeted information when accessed or used by a health care provider or the like. For example, targeted advertisements may be provided to referring doctors when tracking referrals (Step 65), or to users who are reviewing a medical chart log (step 66). Targeted advertisements and information can also be provided on a hand held device when a user accesses the system using such a device (step 68). Pop-up advertisements and targeted information can also be provided to the authorized user when running analytics, based on the type of analytic or report being run (70).

An on-line auction capability 72 is provided by the system to enable vendors of medications, medical devices, and the like, to place advertisements in documents in which certain keywords occur. This is generally illustrated in FIG. 2 and described in more detail below with reference to FIGS. 3 to 6. For example, vendors 74 may wish to place advertisements for migraine medication in any medical record in which the word “migraine” appears. Vendors 1, 2 and 3 (or more) make bids for that keyword in the on-line auction, and the highest bidder will either have their advertisement placed in all documents with that word appearing, or else have their advertisement be the first option that pops up when a doctor is likely to be considering one of their products or services. The highest bidder can then send a file with the desired product advertisement for placement every time the keyword is found. Advertisements are placed in this system at various stages when an authorized user is using the system, for example when they call in dictation via the toll free number and an advertisement or other information is placed at step 55, or when information and advertisements are placed on a document retrieved by a user at the website at step 45. The on-line auction process controls the order of advertisement placement via step 73. Other points at which advertisements can be placed as pop-ups or the like are when the doctor contacts a pharmacy, lab test or x-ray provider to order products or services (step 71), when a doctor prints out care directions or general information (step 72), just before a doctor accesses another medical information website (step 74), when a doctor contacts other health care providers (step 75), or when a doctor orders an information kit or the like (step 76).

In addition to advertisements based on a single keyword, the system enables advertisers to bid for single or multi-tiered keywords. For example, vendors can bid to place an advertisement every time the word “depression” appears, or only when the words “depression” and “backache” appear. The system can exclude any documents in which a certain keyword or image is found. For example, if the word “Alzheimer's” appears in a document, but the string “allergic to Aricept®” is found, then no advertisement for Aricept® is served.

FIGS. 3 to 6 are flow diagrams illustrating software used in this system to manage and augment data, such as medical records. As indicated in FIG. 3, the data management system and method website will have a public or internet portion 80 accessible to all users, and a private or extranet portion 82 accessible only to authorized users and website administrators. Within the private portion are private sites associated with each authorized user in which all their records are stored. For example, if the system is designed for health care practitioners, it may contain patient records, billing records, and the like. Within each private site are sub-sites which have limited information accessible to individual patients, such as their own records or educational or treatment information. The public portion 80 will have information about the company providing the service 84, click-on buttons to sign up for the service 85, a description of the services provided by the site 86, testimonials 88, and a contact page 89.

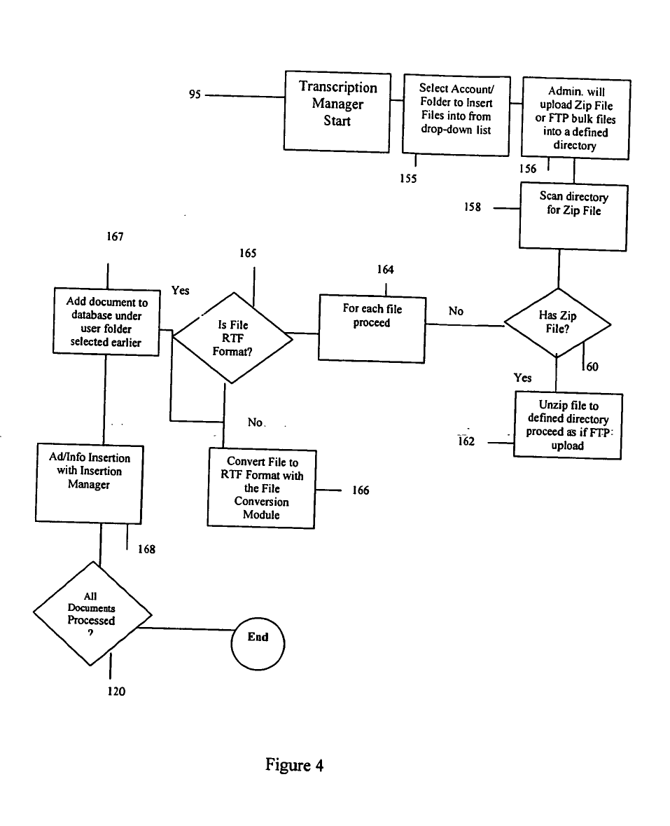

When a user logs on to the website (step 90), they will be directed to the public portion if they do not have a user id and password. If they are a system administrator (step 92), they can access private site administration 94, transcription manager 95, or insertion manager 96 which includes the advertising manager 97. The later three subroutines are illustrated in more detail in FIGS. 4 to 6. Private site administration 94 allows the administrator to add, edit or remove private sites for clients 98. The transcription manager 95 controls scanning, transcribing, and storing of documents dictated or uploaded by the user (101), scanning, transcribing and storing of bulk documents 99, scanning files for keywords that are in the insertion manager 100, rewriting files and inserting advertisements and other targeted information 102, and storing files into the data base 104. When a site is initially set up by a doctor's office, hospital, or the like, the new user may provide all of the paper medical records, which may extend back several years. In step 99, the administrator can scan all the paper records into the system and store them in the private site for that client. The administrator also controls transcribing and storing of new documents in step 99, which will involve the steps indicated in FIG. 2. Documents dictated or dictations uploaded by the user will be transcribed by a transcriptionist or by a computer using voice recognition technology. The transcribed document will than be handled in the same way as scanned or otherwise downloaded documents for storage.

If the user is not an administrator, they are directed to the authorized user site 24, where they can review files 105, fax, email, print and snail mail documents (step 106), or perform administrative functions on their private site (step 108). As noted above, the private site has the option for a patient to review their documents (step 110). The medical professional can also review documents (110), add, edit or remove authorized users (112), and add, edit or remove documents or folders for specific patients (114), for example when a new patient enters the practice.

When the authorized user selects the option to review files (step 105), they can either download a file (step 115) or edit the file on the browser (step 116). At the same time, new records to be transcribed can also be uploaded via the toll free phone line or from the authorized user's computer, as indicated in FIG. 2. If the user wishes to edit an existing, transcribed, scanned, or otherwise uploaded file, the file is first loaded from the data base and converted from RTF into HTML format for display by the file conversion manager (step 118). All existing, saved documents or files in a user's private site will already have been scanned and will have had advertisements and information associated with various keywords in the document. However, this information is not saved with the document or file. Instead, the document is tagged with the name or reference to the advertisement or information. When the document is retrieved by the user, the document is scanned to see if it is already tagged for insertion of information, and advertisements and information are again served on the document (step 120) and appear inline with the HTML page seen on the user's screen when they edit the file. The user then edits or modifies the document (step 122), saves the file (step 123), can perform an optional spell check (step 124), and then approves and digitally signs their approval of the document as final and correct (step 125), whereupon the file is scanned and converted back to RTF (step 126) and saved to the system. A file conversion module 128 for carrying out the file conversion steps is illustrated at the lower left hand corner of FIG. 3, and involves steps of determining whether a file is HTML (130), converting the HTML to RTF (132), determining if the file is RTF (134), and converting RTF to HTML (135), or returning the unchanged file if it is already HTML (136).

The user can also opt to download a file in step 115. This means that they can save the file to their local desktop, save a copy to their private site, view the file as HTML in their browser, and the like. Whenever the user chooses this option, the file is scanned to see if it has already been tagged for insertion of information. If so, the relevant information, including advertisements, is inserted. If not, it is scanned for keywords that are in the insertion manager (step 140), and the file is rewritten with the target advertisements and other information inserted into the file (step 142). The RTF download with inserted advertisements and information is then delivered to the user (step 144).

In step 106, the user can fax, email, or print and standard mail a document. This option enables users to fax or email transcribed or stored documents directly from the online application, simply by clicking a fax or email button and filling in some fields. The user may also select an option of sending out the document by standard mail. They first choose the type of service (fax, email, or standard mail), select the file or files they want to be sent out (step 145), then choose the recipients (146). This will include the names, addresses, fax numbers and/or email addresses. The system then scans the selected file or files for keywords that are in the insertion manager 96, in step 148. The insertion manager will select advertisements and other information to be inserted into the RTF file according to keyword auctions and administrator preference, as discussed in more detail below, if the file is not already tagged for such insertions. The file is then rewritten with the appropriate targeted advertisements and information inserted (step 150). The user can then digitally sign and/or encrypt the letter, email, or fax (step 152). The fax, email, letter or the like is then delivered to the recipients with targeted information inserted on the document (step 154). The advertisements and other information served on the fax, email, or printed letter may or may not be the same as what appears on the online document. When the user selects the standard mail option, the letter will be printed and mailed by the website service. In this case, additional advertisements may be sent within the actual envelope.

The transcription manager 95 is accessible by website administrators only, and is illustrated in more detail in FIG. 4. It is an automated administrative module which uses voice recognition and optical character recognition (OCR) technology to automatically scan, transcribe, and store new documents to be added to a user's site. This part of the system works in concert with the insertion manager as each document is passed to the insertion manager before storage in the database to have any appropriate advertisements or information added, just as if it were entered or uploaded manually by an authorized user. It can bulk import documents into the data management system. The transcription manager can take a large collection of documents in any digital format, do OCR as required, and then use the insertion manager on each document to insert advertisements and information into the documents.

In the transcription manager, the user will first select the user account and folder into which the files are to be inserted, from a drop-down list (step 155). Zip files or FTP bulk files are then uploaded into a defined directory (step 156). The directory is then scanned for zip files (158). If a zip file is located (160), the file is unzipped to a defined directory and uploaded (162). A series of steps is then carried out for each file, starting at step 164. Any non-zipped files located at step 160 proceed directly to step 164. If the file is not in RTF format (step 165), it is converted to RTF (step 166). In step 167, the RTF document or converted RTF document is then added to the data base under the user/folder selected in step 155. It is also sent to the insertion manager for insertion of targeted advertisements and information (step 168). Once all documents have been processed (169), the subroutine ends (170).

Files are sent to the insertion manager 96 for scanning and insertion of information at various points. First, they will be sent by the transcription manager when new documents are being added to the system, whether by scanning, transcribing from audio files, or the like (see step 168 of FIG. 4). Files are also sent to the transcription manager for scanning when a file is downloaded by an authorized user for viewing or other purposes (step 140 of FIG. 3). Another point at which files are sent for scanning and information insertion is when an authorized user wishes to fax, email, or print and snail mail a document (step 148 of FIG. 3).

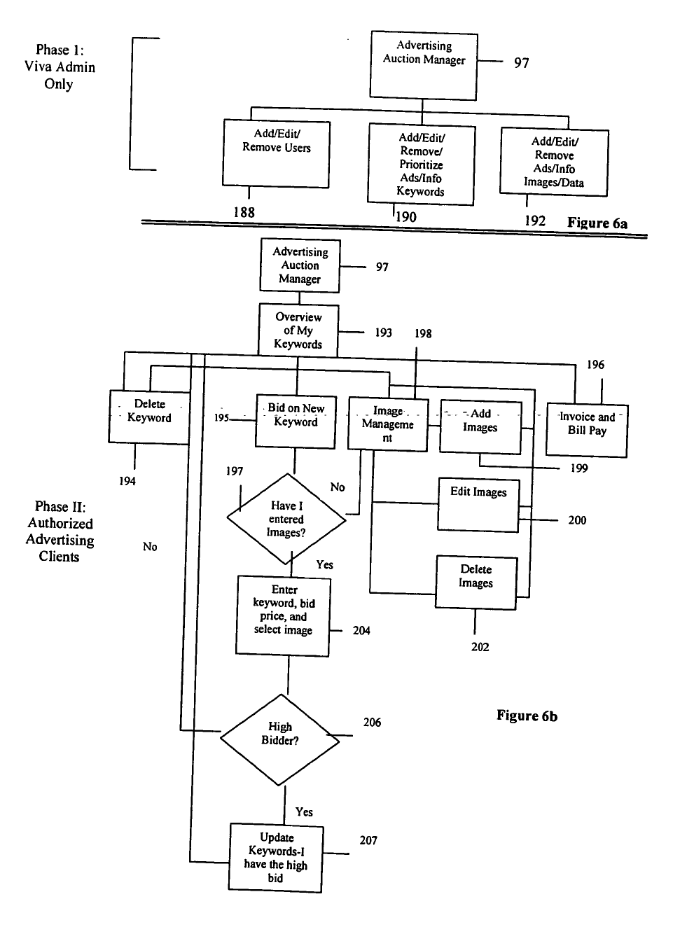

The insertion manager will use a list of saved keywords in order to select advertisements and information to be inserted into a document. The list will include keywords selected by the system administrator and keywords based on active words in the auction or advertising manager 97, which is illustrated in more detail in FIG. 6. RTF documents that require insertion of advertisements or information (172) are provided to the insertion manager, which first determines whether the document has an insertion record (step 174). If it has already been tagged with references to advertisements and information to be inserted, the appropriate advertisements and information are inserted into the document immediately at step 175. If the document has no insertion record, the document is scanned to locate all keywords in the document that meet NLQ (natural language query) requirements (step 176). Natural language query is a system that effectively reduces a document down to its essence by removing or ignoring words such as “a”, “the”, “it”, and the like, and stripping off plurality and other words which are not of interest, creating a list of keywords that may be of interest for matching purposes.

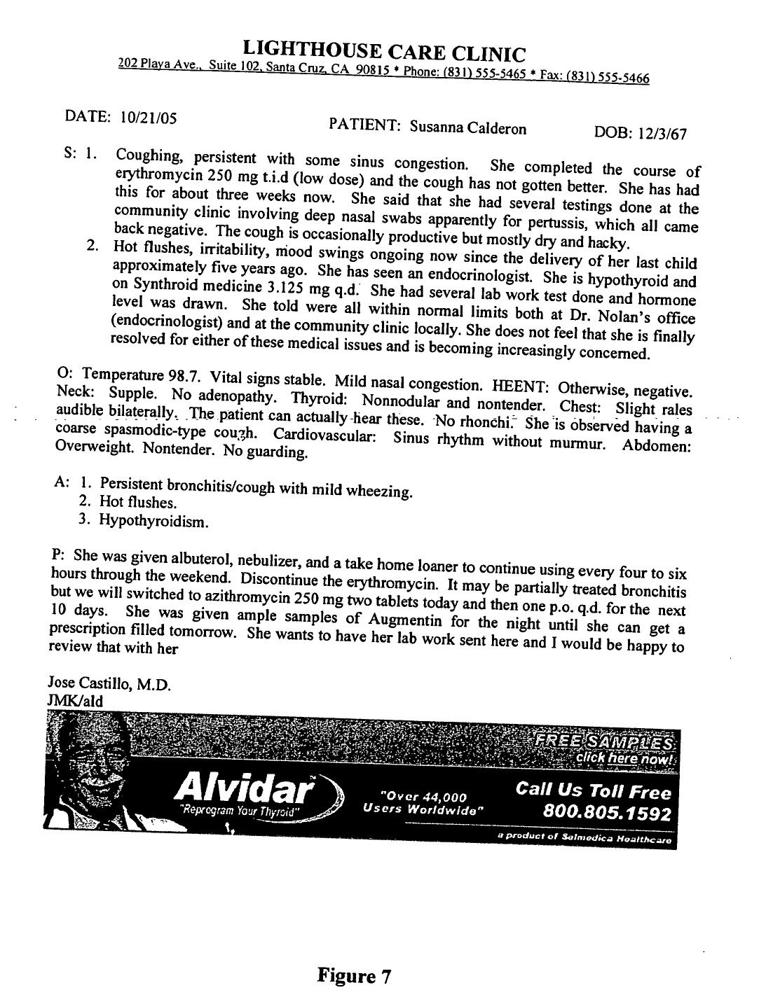

Once the distilled keyword list has been obtained from the document, the list is compared with active keywords in the advertising manager (step 178) as well as keywords associated with other types of information to be inserted, and a list is made of the active keywords found in the document (step 180). These keywords are then sorted by auction value (step 182). According to administrator defined preferences, a number n of advertisements and information are selected to be inserted (step 184), and the advertisements and information selected are inserted into the document database record (step 175). If RTF creation is required (185), the document is rewritten as an RTF file and the advertisements and information are inserted (186). FIG. 7 illustrates an example of a document as it may appear on the screen after an advertisement has been inserted. The advertisement has a button which can be clicked on to find out more information about the product being advertised.

FIG. 6A and 6B illustrate the advertising or auction manager subroutine in more detail. The advertising manager is responsible for keeping track of keywords as well as their order of priority for use by the insertion manager. In FIG. 6A, keywords can be determined manually by a system administrator. The administrator can add, edit or remove users (step 188), add, edit, remove and prioritize advertisements and other information based on keywords (step 190), and can add, edit or remove advertisements, images, information, and other data (step 192). This part of the program controls insertion of non-advertising information into a document. A large variety of different types of information may be added by the advertising manager, and the information may include some or all of the following listed types of information, as well as other types of information:
Targeted pop-up advertisements for medication, medical equipment, and the like;
Links to appropriate websites, books, or support groups based on a diagnosed condition;
Billing codes for certain procedures;
Pertinent information on patient drug allergies and other patient-specific medical or financial information based on the identification of the patient who is discussed in the file (this can be retrieved from the patient's medical history which is also stored on the user's private site);
Menus or order buttons for selecting and ordering medical tests, x-rays or the like and for electronically authorizing prescriptions with a pharmacy or drug distributor;
Links to pharmacies, drug representatives, medical supply companies and the like;
Links for calendaring prescription refills or follow up visits with a patient;
Links to detailed information on drugs or treatments a doctor may be ordering, such as side effects, how a medicine should be taken, drug interactions, what reactions to a drug or treatment are normal or otherwise, drug effectiveness, other health care providers experiences with the same drugs or treatments, and so on;
Access to an online medical glossary;
A button allowing a doctor to automatically print a prescription for a patient with all relevant information filled out;
Useful information for a patient and family members or caregivers for the doctor to print out, such as what side effects may occur and what to do in the event of such side effects, how much and how often medication should be taken, and how it should be taken, what to do if a dose is missed, when to report back to the health care provider, and the like;
A button for a doctor to click on to inform other physicians via email, voicemail, or fax of a treatment they are recommending for a patient they all have in common.

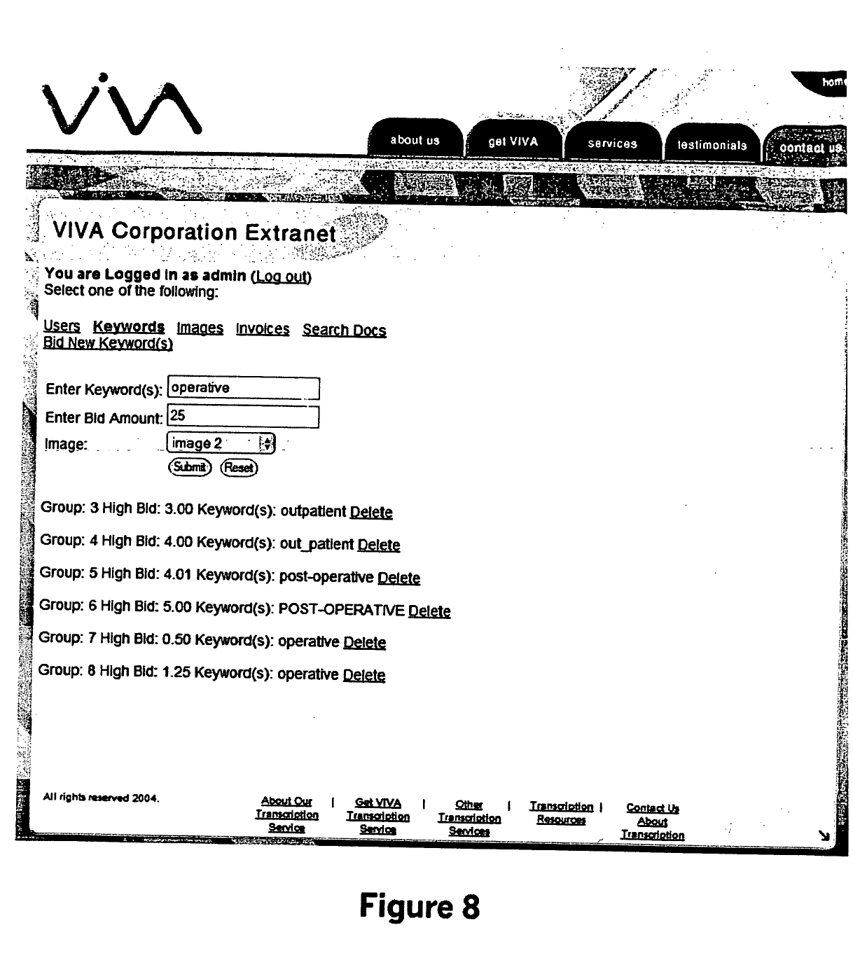

FIG. 6B illustrates how the advertising manager may select and order advertisements to be included in documents where selected keywords are found. This part of the system can be accessed only by system administrators and authorized advertising clients or vendors. In the case of a medical data management system, such clients will be pharmaceutical companies, medical equipment manufacturers, and the like. When each client accesses the system, they will be directed to a screen which has an overview of the keywords they have previously selected, if any (step 193). The user screen of FIG. 8 allows the client to delete a keyword (194), or to bid on a new keyword (195), and also allows them to pay bills (196). The user can then enter images of advertisements they would like to have associated with selected keywords (197), which is done in an image management subroutine (198) in which they can add (199), edit (200) or delete (202) images.

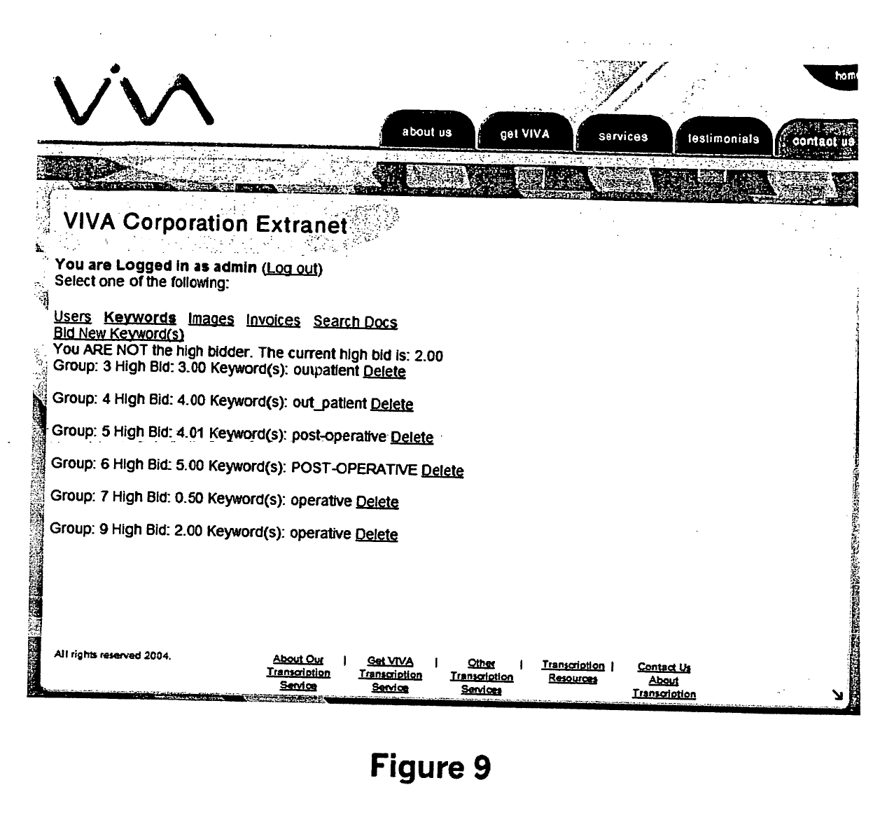

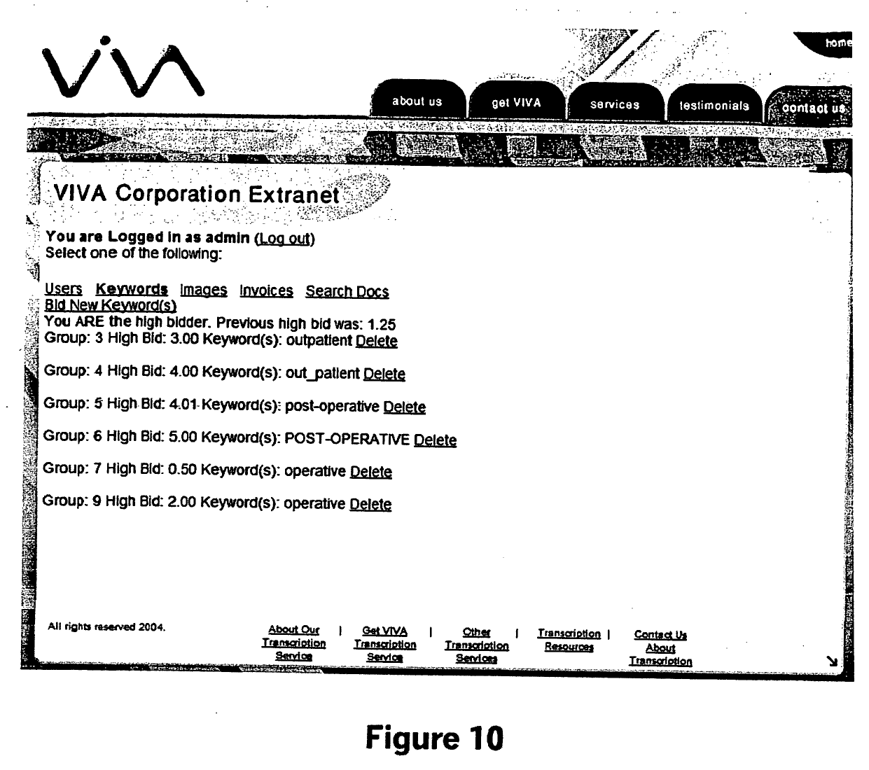

The user then enters the keyword they would like to bid on, the associated image, and the bid price (step 204). In FIG. 8, the user is entering the keyword “operative” along with a bid amount of 0.25 for that keyword (step 205). The system determines whether or not the user is the highest bidder for that keyword (step 206). If they are not the high bidder, they are returned to the overview screen and informed that they are not the high bidder for that word, as shown in the screen display of FIG. 9, which also indicates the high bid for that word. The user can bid again on that word or a different word. If it is determined that the user is the highest bidder at step 206, a new screen display (FIG. 10) is generated with the words “You ARE the high bidder” for that keyword (step 207). The user or client is essentially bidding to be the first option that pops up on the screen when the doctor is likely to be considering one of their products.

Documents that are found to have one or more active keywords in the insertion manager will have advertisements inserted in order of highest bid price first. Each time the advertisement is inserted in a document, the client will be billed an amount equal to their bid price. More than one advertisement may be inserted, in bid order, up to the maximum number of insertions determined by the system administrator. In addition to advertisements, other relevant information and links are provided in the document, as listed above. As has been noted above, the advertising or auction client has the option of bidding for multi-tiered key words, i.e. placing an advertisement only when two related keywords appear in the document. The system is also set up to exclude advertisements if the patient is allergic to the medication concerned.

The data management system and method of this invention allows a medical professional or other business to store their records at an internet accessible private site, to add new records to their site, as well as to view and edit records, and send records to other parties by standard mail, fax or email. The system automatically provides relevant information to the user and to other parties receiving copies of files. The information includes targeted advertisements for products which the user may want to order for clients or patients based on keywords found in the document, as well as other relevant targeted information and services based on selected keywords. In a medical record system, information can include all types of information related to a diagnosed condition of a patient, including billing codes, as well as patient-specific information which may be of relevance, such as recent payment history, known drug allergies, and the like. Information can also include click-on buttons for the doctor or other medical provider to order drugs and other supplies, print prescriptions, authorize prescriptions, medical tests, or the like, as well as to access relevant websites and other sources of information, and to send information to other doctors treating the same patient. This system provides substantial additional value to the user over and above other known data or record managing systems.

Although an exemplary embodiment of the invention has been described above by way of example only, it will be understood by those skilled in the field that modifications may be made to the disclosed embodiment without departing from the scope of the invention, which is defined by the appended claims.

What is claimed is:

1. A data management method, comprising the steps of:
receiving and storing a series of documents in a data base;
selecting a series of keywords and associating each keyword with one or more document inserts, the document inserts comprising advertisements, information, buttons for performing a series of functions, and links;
scanning each document at least once and retrieving a list of keywords from the document;
comparing the retrieved keyword list with the selected keywords and selecting document inserts for at least some of the retrieved keywords in the list which match a selected keyword; and
inserting the document inserts into the document each time it is viewed by an authorized user accessing the data base and viewing the document.

2. The method as claimed in claim 1, further comprising the steps of assigning a value to each keyword found in a document and sorting the keywords found by assigned value, inserting document inserts related to at least some of the keywords found in the document file in order with the information related to the most valuable keyword found listed first, and delivering the document file to the user for viewing on a browser, downloading, or the like.

3. The method as claimed in claim 1, wherein at least some of the document inserts comprise advertisements.

4. The method as claimed in claim 3, further comprising the steps of accepting bids from authorized vendors based on selected keywords, and receiving and storing advertisements associated with keyword bids, the step of comparing a retrieved keyword list from a document with a stored keyword list further comprising assigning a value to any advertisement associated with a keyword found in the document, and inserting at least the advertisement associated with the highest bid value into the document when it is retrieved by an authorized user.

5. The method as claimed in claim 4, wherein the step of accepting bids from authorized vendors comprises conducting an online auction of keywords to be associated with vendor advertisements.

6. The method as claimed in claim 4, wherein the step of inserting an advertisement comprises inserting a predetermined number of advertisements in bid value order into a document.

7. The method as claimed in claim 1, wherein the step of receiving and storing documents comprises receiving audio files and converting the files to text before storing the text document in the data base.

8. The method as claimed in claim 7, wherein the step of receiving and storing documents further comprises scanning paper documents and storing the scanned files in the data base.

9. The method as claimed in claim 7, wherein the step of receiving and storing document further comprises receiving and storing files over a network.

10. The method as claimed in claim 1, further comprising the steps of associating each authorized user with their own private data base of documents, providing authorized users accessing their data base with options of downloading, editing, or requests transmission of documents to selected recipients, and the step of inserting document inserts into documents is carried out each time an authorized user downloads, edits or requests transmission of a selected document.

11. The method as claimed in claim 10, wherein the step of requesting transmission of documents comprises requesting transmission by fax, email, or standard mail.

12. The method as claimed in claim 11, further comprising the step of delivering a document by fax, email, or standard mail to a selected recipient on request by an authorized user.

13. The method as claimed in claim 12, further comprising the step of inserting selected document inserts into a document prior to faxing, emailing, or mailing the document.

14. The method as claimed in claim 1, wherein the document inserts comprise one or more inserts selected from the group consisting of advertisements, pertinent keyword-based information, patient-specific information, billing codes, control buttons on a computer screen for ordering selected items or services, control buttons on a computer screen for printing out order forms or prescriptions associated with the document, relevant website links, and links to send information to selected parties.

15. The method as claimed in claim 14, wherein the selected inserts comprise at least two different inserts from the group.

16. The method as claimed in claim 14, wherein the selected inserts comprise all of the listed inserts in the group.

17. A data storage and management system, comprising:
a central processing unit having at least one data base storing a series of sets of documents each associated with an authorized user of the system and a first list of selected keywords, each keyword associated with at least one predetermined insert for insertion in a document containing that keyword;
the central processing unit having a memory containing program instructions comprising a transcription manager unit for importing documents into the data base, and an insertion manager unit for scanning each document at least once, obtaining a second list of keywords from the document, comparing the second list to the first list and identifying the document insert or inserts associated with each keyword from the first list found in the second list, and inserting at least some of the identified document inserts into the document when a user retrieves the document from the data base.

18. The system as claimed in claim 17, wherein the transcription manager unit comprises means for scanning, transcribing, and storing bulk documents from clients.

19. The system as claimed in claim 17, wherein at least some of the selected inserts comprise advertisements.

20. The system as claimed in claim 19, further comprising an auction manager unit for allowing vendors to enter advertisements into the system and to bid on keywords to be associated with the entered advertisements, and determining the highest vendor bid for each keyword, the insertion manager unit further comprising means for sorting advertisements associated with keywords found in a document by auction value with the highest bidder listed first, and means for inserting a predetermined number of advertisements into a document having associated keywords with the highest bid advertisement inserted first.

21. The system as claimed in claim 19, wherein the selected inserts further comprise information associated with the selected keyword, information specific to an individual who is the subject of the document, billing codes, control buttons on a computer screen for ordering selected items or services, control buttons on a computer screen for printing out order forms or prescriptions associated with the document, relevant website links, and links to send information to selected recipients.
